(19) United States
(12) Patent Application Publication
(10) Pub. No.: US 2024/0332682 A1
(43) Pub. Date: Oct. 3, 2024

(54) RECHARGEABLE BATTERY MODULE

(71) Applicant: SAMSUNG SDI CO., LTD., Yongin-si (KR)

(72) Inventors: Areum JEONG, Yongin-si (KR); Choonghoon LEE, Yongin-si (KR)

(21) Appl. No.: 18/491,589

(22) Filed: Oct. 20, 2023

(30) Foreign Application Priority Data
Apr. 3, 2023 (KR) 10-2023-0043702

(51) Int. Cl. H01M 50/143; H01M 50/213; H01M 50/244; H01M 50/383

(52) U.S. Cl. CPC H01M 50/143; H01M 50/213; H01M 50/244; H01M 50/383

(57) ABSTRACT

A rechargeable battery module is disclosed. A rechargeable battery module comprise: battery cells provided with a venthole; a first holder that supports the battery cells by accommodating one sides of the battery cells; a second holder that supports the battery cells by accommodating the other sides of the battery cells and is coupled to the first holder; a first plate that is provided at one side of the second holder and comprises an outlet formed at a position corresponding to a venthole of each of the battery cells, and a hooking piece protrudes in a diameter direction of the outlet from an inner wall surface of the outlet; and a second plate that is provided at one side of the first plate to block an explosion pressure, flames, and debris discharged through the venthole and the outlet.

### CROSS-REFERENCE TO RELATED APPLICATION

The present application claims priority to and the benefit of Korean Patent Application No. 10-2023-0043702, filed on Apr. 3, 2023, in the Korean Intellectual Property Office, the entire disclosure of which is incorporated herein by reference.

### BACKGROUND

### 1. Field

The present disclosure relates to a rechargeable battery module that reduces or prevents chain explosions of neighboring battery cells if a battery cell explodes.

### 2. Description of Related Art

Unlike a primary battery, a rechargeable battery is a battery that iteratively performs charging and discharging. Small-capacity rechargeable batteries are used for portable small electronic devices, such as mobile phones or laptop computers and camcorders. Large-capacity and high-density rechargeable batteries are used for motor-driving power or for energy storage for hybrid vehicles and electric vehicles.

The rechargeable battery includes an electrode assembly that charges and discharges a current, a case that accommodates the electrode assembly and an electrolyte solution, and an electrode terminal that is connected to the electrode assembly and drawn out to the outside of the case. The electrode assembly may be formed in a jelly roll type formed by winding an electrode and a separator.

An electric vehicle and an energy storage device suitably use large-capacity rechargeable battery modules. The large-capacity rechargeable battery module is provided with a plurality of battery cells. When fire or explosion occurs in a single battery cell of the module, flames or high-temperature gas emitted from the battery cell may propagate to one or more other adjacent battery cells, causing a chain explosion.

A technique to reduce or prevent the likelihood of a chain explosion may be useful. For example, there is a potting technology that covers a positive electrode of the battery cell with foamed urethane or a silicone material. The potting material protects the battery cell from air and moisture at normal times, and, in case of emergency, such as thermal runaway, the vent gas and debris of the battery cell are smoothly discharged as the foamed air gap is opened, and transition of the escaped debris to the surrounding cells can be reduced or prevented, thereby reducing or preventing the likelihood of a chain explosion.

However, potting may be relatively expensive and process management may be difficult, causing an increase in the total processing cost of the rechargeable battery module. Further, the potting material may penetrate between a cap assembly in a cylindrical battery to block the vent open of the battery cell, thereby causing side effects, such as a side explosion (e.g., a side rupture).

### SUMMARY

One or more embodiments provide a rechargeable battery module that reduces or prevents the likelihood of a chain explosion of peripheral battery cells by limiting discharge of an electrode assembly if the battery cell explodes.

A rechargeable battery module according to one or more embodiments includes battery cells defining a venthole, a first holder accommodating first sides of the battery cells to support the battery cells, a second holder coupled to the first holder, and accommodating second sides of the battery cells to support the battery cells, a first plate at one side of the second holder, defining an outlet corresponding to the venthole, and including a hooking piece protruding in a diameter direction of the outlet from an inner wall surface at least partially defining the outlet, and a second plate at one side of the first plate, and configured to block an explosion pressure, flames, or debris discharged through the venthole and the outlet.

The battery cells may include a cylindrical rechargeable battery.

The hooking piece may be provided in plurality, wherein the hooking pieces are separated by a distance.

The battery cells may respectively include electrode assemblies, wherein the hooking pieces include an elastic material configured to limit discharge of the electrode assembly in a battery cell explosion.

The hooking piece may protrude obliquely from the inner wall surface toward a corresponding one of the battery cells.

The hooking piece may protrude at an angle range of 29 degrees to 31 degrees toward a corresponding one of the battery cells from the inner wall surface.

The battery cells may respectively include electrode assemblies, wherein the hooking piece is configured to limit discharge of the electrode assembly in a battery cell explosion, and includes an elastic material configured to be deformed upwardly by a discharge pressure of the electrode assembly.

The hooking piece may protrude with a length of about ⅓ to about ¼ of a diameter of the outlet.

The hooking piece may have a first width at the inner wall surface, and a second width at an end protruding into the outlet, the first and second widths being different from each other.

The hooking piece may include a friction protrusion protruding from a surface thereof facing a corresponding one of the battery cells.

The hooking piece may be provided in plurality, wherein at least one friction protrusion protrudes from each of the surfaces of the hooking pieces facing a corresponding one of the battery cells.

A distance between a corresponding one of the battery cells and the hooking piece may be in a range from about 9 mm to about 10 mm.

According to one or more embodiments, if a part of a plurality of battery cells explodes abnormally, it is possible to effectively reduce or prevent the likelihood of the corresponding electrode assembly being discharged to the outside from the exploded battery cell, and the likelihood of one or more secondary explosions occurring in adjacent battery cells can be reduced or prevented, thereby improving stability.

### BRIEF DESCRIPTION OF THE DRAWINGS

FIG. 1 is a schematic exploded perspective view of a rechargeable battery module according to one or more embodiments of the present disclosure.

FIG. 2 is a cross-sectional view of FIG. 1, taken along the line II-II.

FIG. 3 is a cross-sectional perspective view of a cylindrical battery cell applied to FIG. 1.

FIG. 4 is a perspective view of a main part schematically showing a state in which the hooking piece is formed in the outlet formed on the first plate according to one or more embodiments of the present disclosure.

FIG. 5 is a top plan view of the main part schematically showing a state in which the hooking piece is formed on the outlet formed on the first plate in FIG. 1.

FIG. 6 is a cross-sectional view that schematically illustrates main parts of a rechargeable battery module according to one or more other embodiments of the present disclosure.

FIG. 7 is a perspective view that schematically illustrates a state in which a hooking piece is formed in an outlet of a first plate according to one or more other embodiments of the present disclosure.

FIG. 8 is a cut-out view of FIG. 7, taken along the line VIII-VIII, and schematically illustrates a main part in a discharge state of the electrode assembly of the battery cell by partially incising the state where the hooking piece is formed in the outlet of the first plate.

FIG. 9 is a main part view that schematically illustrates a state of elastic deformation of a hooking piece if an electrode assembly is discharged in a battery cell according to one or more other embodiments of the present disclosure.

FIG. 10 schematically illustrates a state in which friction protrusions are formed on a hooking piece formed on a first plate according to one or more yet other embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The present disclosure covers all modifications, equivalents, and replacements within the idea and technical scope of the present disclosure. Further, each of the features of the various embodiments of the present disclosure may be combined or combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression such as “at least one of A and B” and “at least one of A or B” may include A, B, or A and B. As used herein, “or” generally means “and/or,” and the term “and/or” includes any and all combinations of one or more of the associated listed items. For example, the expression such as “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

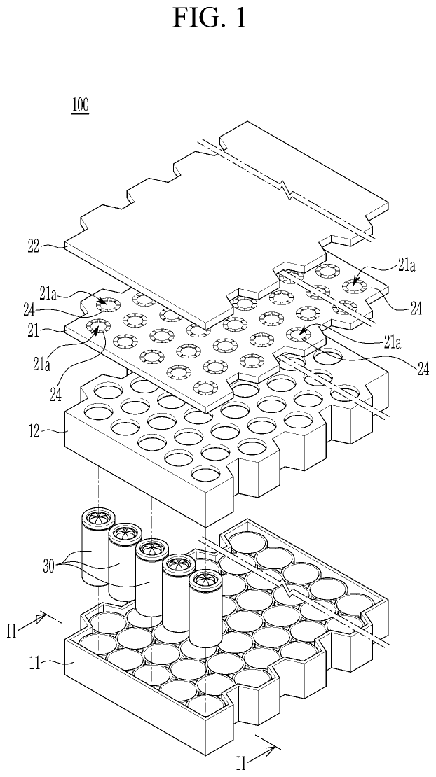

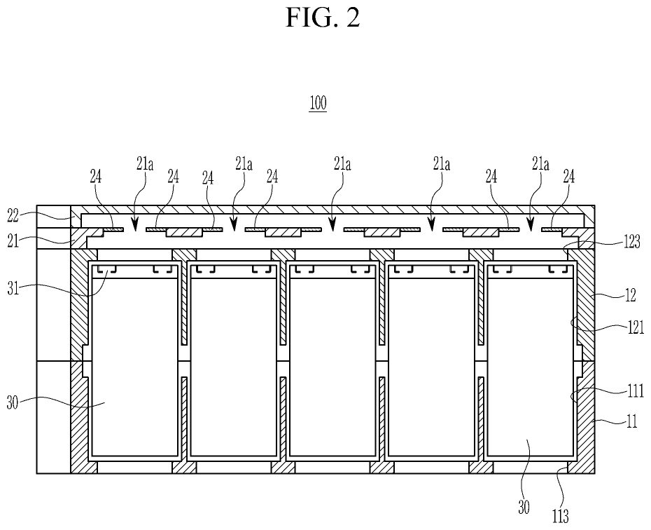

FIG. 1 is a schematic exploded perspective view of a rechargeable battery according to one or more embodiments of the present disclosure, and FIG. 2 is a cross-sectional view of FIG. 1, taken along the line II-II.

As shown in FIG. 1 and FIG. 2, a rechargeable battery module 100 according to one or more embodiments of the present disclosure includes a plurality of battery cells 30 provided with a venthole 31, a first holder 11 supporting the battery cells 30 by accommodating first sides, or ends, of the battery cells 30, a second holder 12 supporting the battery cells 30 by accommodating second sides, or ends, of the battery cells 30 and coupled to the first holder 11, a first plate 21 provided at one side of the second holder 12 and including, or defining, an outlet 21a provided at a position corresponding to a venthole of each of the battery cells 30, and also including a hooking piece 24 protruding radially from, or protruding in a diameter direction of, the outlet 21a from an inner wall surface of the outlet 21a, and a second plate 22 located at one side of the first plate 21, the hooking piece 24 for blocking the explosion pressure, flame, and debris discharged through the venthole 31 and the outlet 21a.

As one or more embodiments, the battery cell 30 may be formed as a cylindrical rechargeable battery having a venthole 31.

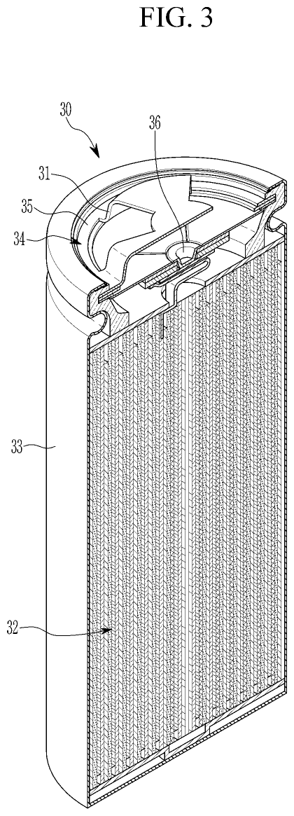

FIG. 3 is a cross-sectional perspective view of a cylindrical battery cell applied to FIG. 1.

As shown in FIG. 3, a cylindrical battery cell 30 may include an electrode assembly 32 for performing charging and discharging, a case 33 embedding, or housing, the electrode assembly 32, and a cap assembly 34 electrically connected to the electrode assembly 32, and coupled to an opening of the case 33 in an insulated state.

The cap plate 35 forming the cap assembly 34 has, or defines, a venthole 31, and vent gas, explosion pressure, flame, and debris may be discharged through the venthole 31 if the vent 36 is cut or broken.

Referring back to FIG. 1 and FIG. 2, the first holder 11 may form a plurality of first accommodating portions that support the battery cells 30 by accommodating first/lower portions of the battery cells 30.

In one or more embodiments, the second holder 12 may form a plurality of second accommodating portions 121 that support the battery cells 30 by accommodating second/upper portions of the battery cells 30. The second holder 12 may be coupled to the first holder 11 to accommodate the battery cells 30 in the first and second accommodating portions 111 and 121.

For example, the first holder 11 may include a first protrusion 113 to support the lower portion of one side of the battery cell 30, and the second holder 12 may include a second protrusion 123 to support the upper portion of the other side of the battery cell 30. The first and second protrusions 113 and 123 may reduce or prevent the likelihood of the battery cell 30 escaping in the vertical direction in the drawing in the first and second holders 11 and 12.

The first plate 21 may be provided on an upper portion of one side of the second holder 12 and a plurality of outlets 41 may be formed at positions corresponding to the ventholes 31 of the respective battery cells 30. A plurality of hooking pieces 24 may protrude from an inner wall surface of the outlet 41. The action and configuration of the hooking piece 24 will be described below.

The first plate 21 is installed on the upper side of the plurality of battery cells 30 in a state in which they are inserted and fixed into the first holder 11 and the second holder 12, and thus, if a part of the battery cell 30 explodes, the gas inflow due to the explosion occurring in the direction of the adjacent battery cell 30 can be blocked.

In one or more embodiments, the second plate 22 is located on one side of the first plate 21 and installed to block vent gas, explosion pressure, flame, and debris discharged through the venthole 31 and the outlet 21a.

The hooking piece 24 may protrude toward the outlet 21a of the first plate 21.

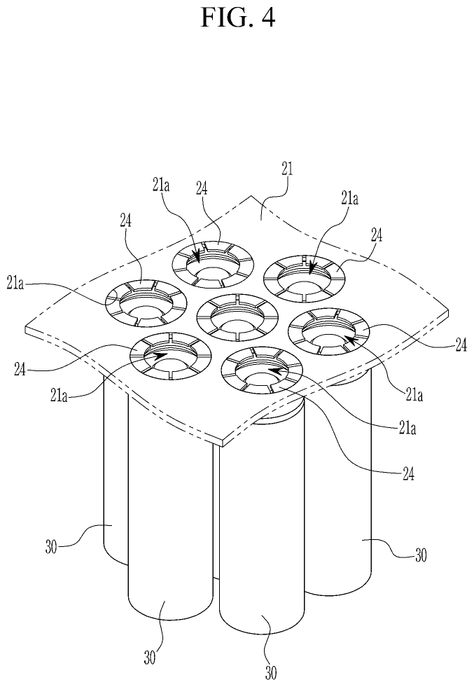

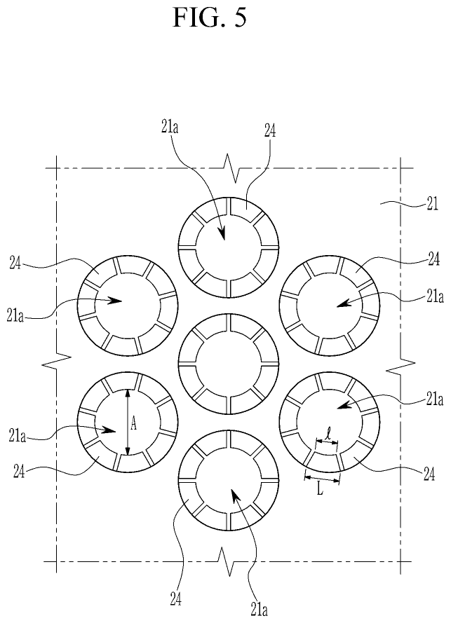

FIG. 4 is a perspective view of a main part schematically showing a state in which the hooking piece is formed in the outlet formed on the first plate according to one or more embodiments of the present disclosure, and FIG. 5 is a top plan view of the main part schematically showing a state in which the hooking piece is formed on the outlet formed on the first plate in FIG. 1.

As shown in FIG. 4 and FIG. 5, the hooking piece 24 may protrude in the diameter direction of the outlet 21a (e.g., may protrude radially, or may protrude in a direction opposite to a radial direction) from the upper inner wall surface of the outlet 21a formed on the first plate 21. As described, the hooking piece 24 is formed at the outlet 21a to reduce or prevent the likelihood of an electrode assembly escaping to the outside if the battery cell 30 explodes. This will be described in detail below.

The hooking pieces 24 may protrude in plurality from the inner wall surface of the outlet 21a in the diameter direction of the outlet 21a. It is illustratively described that eight hooking pieces 24 protrude radially on, or from, the inner wall surface of (e.g., an inner wall defining) outlet 21a. However, the present disclosure is not necessarily limited that the eight hooking pieces 24 protrude from the inner wall surface of the outlet 21a, and it may be suitable to change the diameter of the outlet 21a, or to appropriately change the number of hooking pieces 24 in a range of six to eight hooking pieces in response to, or based on, the discharge pressure of the electrode assembly.

For example, on the basis of the diameter of the opening of the outlet 21a being about 12 mm (refer to A in FIG. 5), eight hooking pieces 24 may protrude from the inner wall surface of the outlet 21a. When the diameter of the opening of the outlet 21a is changed, the number of protruding hooking pieces 24 may also be changed.

The hooking piece(s) 24 protrudes in multiple radial directions along the inner wall surface of the outlet 21a, and may be formed of a metal material with elastic force to stably support the external escape of the electrode assembly discharged from the battery cell 30 in the event of an explosion or similar situation.

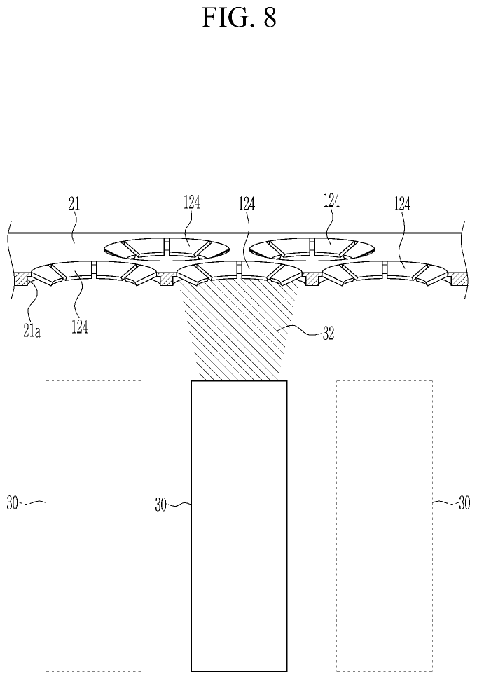

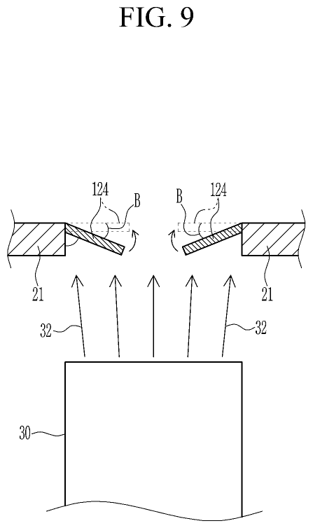

Accordingly, if a part of the plurality of battery cells 30 explodes and an electrode assembly 32 (refer to FIG. 8 and FIG. 9) is discharged in the direction of the outlet 21a from inside the battery cell 30, the hooking piece 24 may interfere with the electrode assembly inside the outlet 21a to limit the external discharge of the electrode assembly.

Because the hooking piece 24 protrudes in the diameter direction of the outlet 21a from the inner wall surface of the upper edge position of the outlet 21a, the outlet 21a may be able to perform a reducing action, and thus the likelihood of the electrode assembly 32 moved through the outlet 21a escaping to the outside can be reduced or prevented.

For this, the hooking piece 24 may protrude from the inner wall surface of the outlet 21a in a trapezoid shape (e.g., a generally trapezoidal shape) in which a first width L connected to the inner wall surface of the outlet 21a and a second width I of an end protruding into the outlet 21a are different from each other.

Accordingly, the hooking piece 24 reduces or prevents the likelihood of the electrode assembly 32 escaping to the outside of the first plate 21 due to interference with the electrode assembly 32, such that a secondary damage, which may occur if a portion(s) of the electrode assembly discharged by the explosion contacts the adjacent battery cell 30, can be reduced or prevented.

The hooking piece 24 may protrude from the inner wall surface of the outlet 21a with a length of about ⅓ about to ¼ of the diameter of the outlet 21a to sufficiently limit the occurrence of the electrode assembly 32 moving through the outlet 21a.

In one or more embodiments, a distance between the battery cell 30 and the hooking piece 24 is spaced in a range of about 9 mm to about 10 mm, and may be spaced apart from each other by about 10 mm, for example. Accordingly, the electrode assembly discharged from the battery cell 30 can be stably hooked and supported through the hooking piece 24.

Accordingly, if the battery cell 30 explodes, the gas can be smoothly discharged through the outlet 21a, and the likelihood of the electrode assembly 32 escaping to the outside of the first plate 21 can be reduced or prevented by the hooking piece 24, thereby enhancing the stability of the rechargeable battery module 100.

As described above, stability of the rechargeable battery module 100 can be improved by effectively reducing or preventing the likelihood of the electrode assembly 32 being discharged externally if some of the plurality of battery cells 30 explode, and reducing or preventing the likelihood of secondary explosions of the battery cells 30.

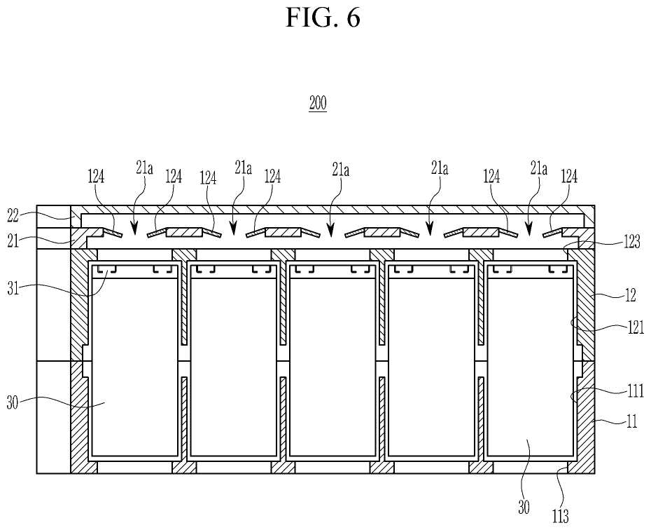

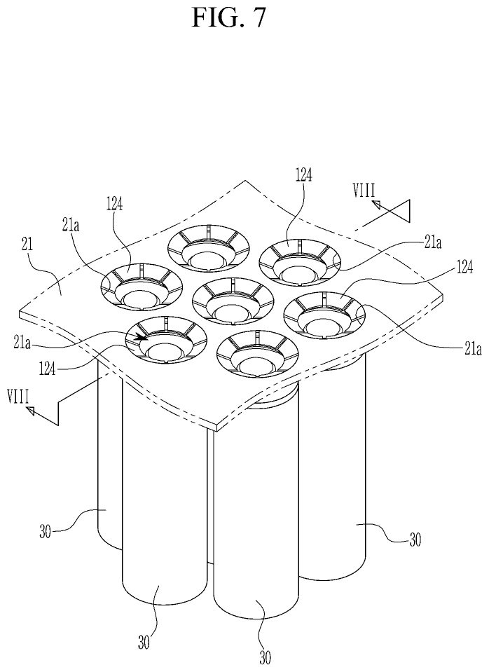

FIG. 6 is a cross-sectional view that schematically illustrates a main part of a rechargeable battery module according to one or more other embodiments of the present disclosure, FIG. 7 is a perspective view that schematically illustrates a state in which a hooking piece is formed in an outlet of a first plate according to one or more other embodiments of the present disclosure, FIG. 8 is a cut-out view of FIG. 7, taken along the line VIII-VIII, and schematically illustrates a main part in a discharge state of the electrode assembly of the battery cell by partially incising the hooking piece that is formed in the outlet of the first plate, and FIG. 9 is a main part view that schematically illustrates a state of elastic deformation of a hooking piece if an electrode assembly is discharged in a battery cell according to one or more other embodiments of the present disclosure. Hereinafter, the same reference number as FIG. 1 to FIG. 5 indicates the same or similar member of the same or similar function. Hereinafter, detailed descriptions of the same reference numerals are omitted.

As shown in FIG. 7 to FIG. 9, a plurality of hooking pieces 124 of a rechargeable battery module 200 according to one or more other embodiments of the present disclosure may protrude obliquely in a direction of a battery cell 30 from an inner wall surface of an outlet 21a.

As described, because the plurality of hooking pieces 124 protrude obliquely in the direction of the battery cell 30 from the inner wall surface of the outlet 21a, if an electrode assembly 32 discharged upon explosion of the battery cell 30 contacts the hooking piece 124, the hooking piece 24 may be elastically deformed in an upper direction of the outlet 21a.

The hooking piece 124 may protrude at an angle range of about 29 degrees to about 31 degrees in a direction toward the battery cell based on a surface of a first plate 21 from the inner wall surface of the outlet 21a. For example, the hooking piece 124 may protrude at an angle of about 30 degrees (refer to B in FIG. 9) in the direction of the battery cell 30 based on the surface of the first plate 21 to properly elastically support the discharge pressure of the battery cell 30.

Therefore, the elastically deformed plurality of battery cells 30 may reduce an opening diameter of the outlet 21a, thereby effectively limiting the discharge of the electrode assembly 32 to the outside through the outlet 21a.

In one or more embodiments, the hooking piece 124 may buffer the discharge pressure in the process of discharging the electrode assembly 32 in the event of an abnormal explosion of the battery cell 30, and thus it is possible to reduce or prevent the likelihood of the electrode assembly 32 being discharged in the direction of the adjacent battery cell 30.

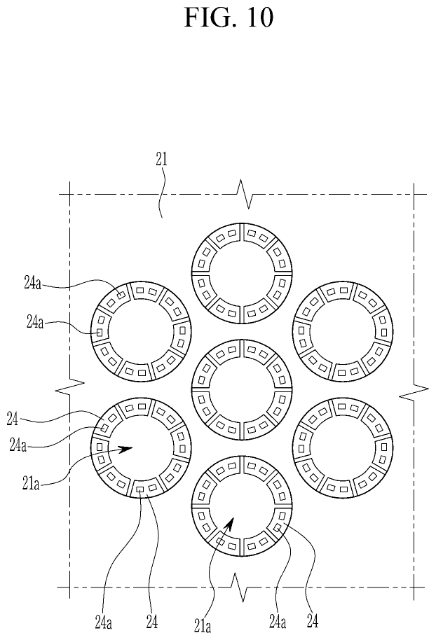

FIG. 10 schematically illustrates a state in which friction protrusions are formed on a hooking piece formed on a first plate according to one or more yet other embodiments of the present disclosure. Hereinafter, the same reference number in FIG. 1 to FIG. 9 indicates the same or similar member of the same or similar function. Hereinafter, detailed descriptions of the same reference numerals are omitted.

As shown in FIG. 10, a friction protrusion 24a may be formed on a surface that faces a battery cell 30 in a plurality of hooking pieces 23 according to one or more yet other embodiments of the present disclosure.

Therefore, the friction protrusion 24a increases a contact area of an electrode assembly with the hooking piece 24 inside an outlet 21a, such that the interference between the electrode assembly and the hooking piece 24 is increased or maximized, thereby effectively limiting the external discharge of the electrode assembly.

While this disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims, with functional equivalents thereof to be included therein.

Description of Some Reference Characters

| | |
|---|---|
| 11 first holder | 12 second holder |
| 21 first plate | 21a outlet |
| 22 second plate | 24, 124 hooking piece |
| 24a friction protrusion | 30 battery cell |
| 32 electrode assembly | 33 case |
| 34 cap assembly | |

What is claimed is:

1. A rechargeable battery module comprising:
battery cells defining a venthole;
a first holder accommodating first sides of the battery cells to support the battery cells;
a second holder coupled to the first holder, and accommodating second sides of the battery cells to support the battery cells;
a first plate at one side of the second holder, defining an outlet corresponding to the venthole, and comprising a hooking piece protruding in a diameter direction of the outlet from an inner wall surface at least partially defining the outlet; and
a second plate at one side of the first plate, and configured to block an explosion pressure, flames, or debris discharged through the venthole and the outlet.

2. The rechargeable battery module as claimed in claim 1, wherein the battery cells comprise a cylindrical rechargeable battery.

3. The rechargeable battery module as claimed in claim 1, wherein the hooking piece is provided in plurality, and wherein the hooking pieces are separated by a distance.

4. The rechargeable battery module as claimed in claim 3, wherein the battery cells respectively comprise electrode assemblies, and
wherein the hooking pieces comprise an elastic material configured to limit discharge of the electrode assembly in a battery cell explosion.

5. The rechargeable battery module as claimed in claim 1, wherein the hooking piece protrudes obliquely from the inner wall surface toward a corresponding one of the battery cells.

6. The rechargeable battery module as claimed in claim 5, wherein the hooking piece protrudes at an angle range of 29 degrees to 31 degrees toward a corresponding one of the battery cells from the inner wall surface.

7. The rechargeable battery module as claimed in claim 5, wherein the battery cells respectively comprise electrode assemblies, and
wherein the hooking piece is configured to limit discharge of the electrode assembly in a battery cell explosion, and comprises an elastic material configured to be deformed upwardly by a discharge pressure of the electrode assembly.

8. The rechargeable battery module as claimed in claim 1, wherein the hooking piece protrudes with a length of about ⅓ to about ¼ of a diameter of the outlet.

9. The rechargeable battery module as claimed in claim 1, wherein the hooking piece has a first width at the inner wall surface, and a second width at an end protruding into the outlet, the first and second widths being different from each other.

10. The rechargeable battery module as claimed in claim 1, wherein the hooking piece comprises a friction protrusion protruding from a surface thereof facing a corresponding one of the battery cells.

11. The rechargeable battery module as claimed in claim 9, wherein the hooking piece is provided in plurality, and wherein at least one friction protrusion protrudes from each of the surfaces of the hooking pieces facing a corresponding one of the battery cells.

12. The rechargeable battery module as claimed in claim 1, wherein a distance between a corresponding one of the battery cells and the hooking piece is in a range from about 9 mm to about 10 mm.
